(19) United States
(12) Patent Application Publication
(10) Pub. No.: US 2004/0103425 A1
(43) Pub. Date: May 27, 2004

(54) Disc cartridge

(75) Inventor: Makoto Nagasato, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/685,522

(22) Filed: Oct. 16, 2003

(30) Foreign Application Priority Data
Oct. 31, 2002 (JP) 2002-318796
Dec. 27, 2002 (JP) 2002-381572

(51) Int. Cl. G11B 23/03

(52) U.S. Cl. 720/728; 720/725

(57) ABSTRACT

A disc cartridge according to an aspect of the present invention allows easy draw out and insertion of an optical disc from/into a cartridge, and has a main wall opposite to one surface of an optical disc, a side wall provided in the circumference of the main wall, a disc holding claw extending from the side wall just like holding the optical disc between the main wall, and a handling area.

### CROSS-REFERENCE TO RELATED APPLICATIONS

This application is based upon and claims the benefit of priority from the prior Japanese Patent Applications No. 2002-318796, filed Oct. 31, 2002; and No. 2002-381572, filed Dec. 27, 2002, the entire contents of both of which are incorporated herein by reference.

### BACKGROUND OF THE INVENTION

1. Field of the Invention

The present invention relates to a disc cartridge which requires no complex assembly process, and allows easy draw out and insertion of a disc medium.

2. Description of the Related Art

For example, a general play-only optical disc represented by a music CD may be put in an outer case for storing, but when inserting into or out off from a player, the disc is handled unprotected.

Thus, the loading mechanism of a player is constructed assuming loading of an unprotected optical disc.

An information writable optical disc such as CD-R/RW is also taken out of a cartridge and handled as an unprotected disc just like a CD, when playing with a play-only disc unit.

A play-only optical disc contained in a case is held at a fixed position through its own center hole, for example. Namely, the recording surface of an optical disc is supported at a fixed position inside of the case without contacting any part of the case interior.

Therefore, when a user is going to take out an optical disc from a case, the edge of the disc held at predetermined position in the case is supported (by the user).

Generally, a data recordable or rewritable optical disc is lower than a play-only disc in the data recording/playback reliability when there is a stain or damage.

Therefore, a recordable or rewritable optical disc is protected by a cartridge, and is loaded in a recording/playback unit while contained in the cartridge case.

The Jpn. Pat. Appln. KOKAI Publication No. 9-213042, Summary, FIG. 1, Paragraph [0014] has proposed a cartridge 1, as a disc cartridge to be set in a recording/playback unit while containing an optical disc inside, which has a flat base unit (a lower case 4) and a flat cover unit (an upper case 3) attached openable through the base, and in which an optical disc 2 is put in between the base unit and the cover unit. This document describes that the optical disc 2 can be taken out by opening the cover of the cartridge.

When an optical disc unit is used as a recording unit in a camcorder or the like, an optical disc is often handled outdoors. Therefore, a disc cartridge becomes indispensable for handling an optical disc without touching the recording surface.

When playing an optical disc with an optical disc unit applicable to a cartridge, an optical disc is loaded into the disc unit while contained in a cartridge.

Therefore, a cartridge is loaded to a predetermined position by the loading mechanism of the disc unit, and an optical pickup head for recording/playing accesses the recording surface of the optical disc through an access window formed in the cartridge.

An optical disc used for the camcorder or the like may be played with an optical disc unit which is not applicable to a cartridge. In this case, it is necessary to take out the optical disc from a cartridge, and can handle as an unprotected disc.

As a method of taking out an optical disc from a cartridge, it is general in the above-mentioned disc cartridge to turn over the whole cartridge by one hand leaving the cover opened, and receive the disc by the other hand, or insert a finger into the center hole of the disc avoiding the recording surface, or hold the edges of the disc.

However, in the above-mentioned disc cartridge, it is necessary to open the cover unit as one step of the disc taking out process. And, the disc must be taken out from the cartridge while the cover is open.

Taking out the disc with the cover open is likely to cause a problem, for example, dropping the disc when using the disc outdoors with the camcorder.

Further, taking out the disc with the cover open is troublesome for the user, and causes a fingerprint or scratch on the disc surface.

### BRIEF SUMMARY OF THE INVENTION

It is an object of an aspect of the present invention is to provide a disc cartridge which allows easy and secure draw out of a disc medium loaded inside, and prevents loss of recorded data.

According to an aspect of the present invention, there is provided a disc cartridge which can rotatably contain and permits draw out of an optical disc having a recording surface, and can be inserted into a recording/playing unit from a predetermined direction with the recording medium inserted, comprising:

a main wall which is formed opposite to the recording surface of an optical disc;

a side wall which extends from the circumference of the main wall, and covers at least a part of the circumference of the optical disc;

a disc drop prevention member which extends from the side wall to be parallel with the main wall just like surrounding the optical disc; and

a handling projection area which extends parallel to the main wall from the side wall opposite to the predetermined direction when inserting into the recording/playing unit.

According to another aspect of the present invention, there is provided a disc cartridge which can rotatably contain and permits draw out of a disc-like recording medium having a recording surface, and can be inserted into a recording/playing unit from a predetermined direction with the recording medium inserted, comprising:

a main wall which is formed opposite to the recording surface of an optical disc;

an opening which is provided in a predetermined location of the main wall;

a side wall which extends from the circumference of the main wall, and covers at least a part of the circumference of the optical disc;

at least one recording medium drop prevention member, which extends from the side wall to be parallel with the main wall just like surrounding the optical disc; and

at least one cartridge holding projection area, which can prevent the contact with the recording surface of the recording medium, when inserting into the recording/playing unit.

According to a further another aspect of the present invention, there is provided a disc cartridge comprising:

a flat part which includes an opening to expose the recording surface of a recording medium to be contained, and occupies a main area;

a side wall which is formed in one body with the flat part in the circumference of the flat part, and contains the recording medium in the hollow space defined by the flat part;

a notch which is provided in a part of the side wall in one body with the flat part; and

at least two projection members in the side wall and almost parallel to the flat part, which can prevent the recording medium from going out of the hollow space and contacting to the recording surface of the recording medium while the recording medium is being inserted.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1A is a schematic diagram explaining a disc cartridge according to an embodiment of the present invention;

FIG. 1B is a fragmentary cross-sectional view taken along the I-I line of the disc cartridge shown in FIG. 1A;

FIG. 2 is a schematic diagram explaining the disc cartridge shown in FIGS. 1A and 1B, with an optical disc loaded as a recording medium;

FIG. 3 is a schematic diagram explaining the disc cartridge shown in FIGS. 1A, 1B and FIG. 2, with an optical disc draw out or loaded;

FIG. 4 is a schematic diagram explaining a modification of the disc cartridge shown in FIGS. 1A, 1B and FIG. 2;

FIG. 5A is a schematic diagram explaining another modification of the disc cartridge shown in FIGS. 1A, 1B and FIG. 2;

FIG. 5B is a fragmentary cross-sectional view taken along the V-V line of the disc cartridge shown in FIG. 5A;

FIG. 6 is a schematic diagram explaining another modification of the disc cartridge shown in FIGS, 1A, 1B, FIG. 2 to FIG. 4, and FIGS. 5A and 5B;

FIG. 7 is a schematic diagram explaining the disc cartridge shown in FIG. 6, with an optical disc loaded as a recording medium;

FIG. 8 is a schematic diagram explaining draw out or loading of an optical disc from/into the disc cartridge shown in FIGS. 6 and 7;

FIG. 9 is a schematic diagram explaining a modification of the disc cartridge shown in FIGS. 6 and 7;

FIG. 10 is a schematic diagram explaining another modification of the disc cartridge shown in FIGS. 6 and 7;

FIG. 11 is a schematic diagram explaining another modification of the disc cartridge shown in FIGS. 1A, 1B, FIGS. 2 to 4, and FIGS. 5A and 5B;

FIG. 12 is a schematic diagram explaining the disc cartridge shown in FIG. 11, with an optical disc loaded as a recording medium;

FIG. 13 is a schematic diagram explaining the disc cartridge shown in FIGS. 11 and 12, with an optical disc draw out or loaded;

FIG. 14 is a schematic diagram explaining a modification of the disc cartridge shown in FIGS. 11 and 12; and

FIG. 15 is a schematic diagram explaining another modification of the disc cartridge shown in FIGS. 11 and 12.

### DETAILED DESCRIPTION OF THE INVENTION

Hereinafter the embodiments of the present invention will be explained in detail with reference to the accompanying drawings.

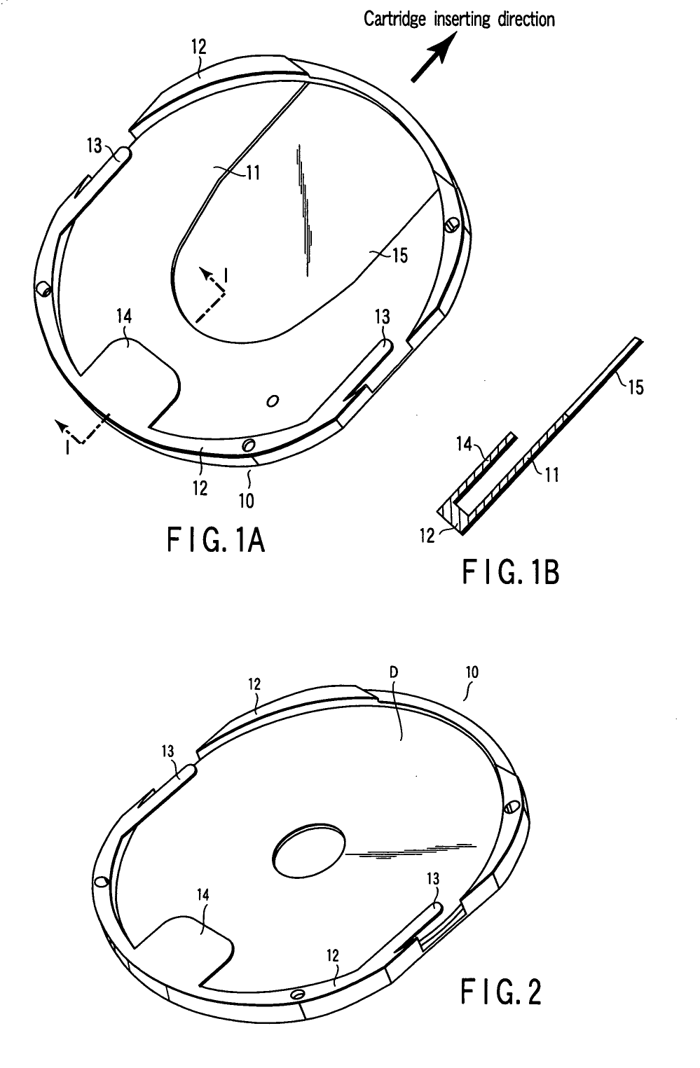

As shown in FIGS. 1A, 1B and FIG. 2, a disc cartridge 10, which can contain an optical disc D or an information recordable and playable medium (the disc D is not set in FIGS. 1A and 1B), includes a main wall 11 (plane part) which functions as a base part; a side wall 12 provided in the circumference of the main wall 11, a disc holding claw (disc holding portion) 13 which is formed to hold the optical disc D (refer to FIG. 2) inserted into the hollow space defined by the main wall 11 and side wall 12, between the main wall 11; and a handling projection 14. The disc cartridge 10 is flat and substantially circular.

In other words, the disc cartridge 10 includes a cover member (main wall) 11 which covers a recording medium (an optical disc D) except the predetermined area of the recording surface; a side wall 12 which extends a predetermined height from the circumference of the cover member 11; a handling area 14 which extends from the side wall 12 to make a predetermined angle against the cover member 11, and can provide a predetermined interval against the recording surface of the optical disc D; and a guide member (a disc holding claw) 13 which extends from the side wall 12 to make a predetermined angle against the cover member 11, and can prevent coming off (dropping) of the optical disc D from the hollow space defined by the cover member 11 and the side wall 12.

Further, in other words, the disc cartridge 10 is a disc cartridge which contains rotatably an optical disc D as a recording medium having a recording surface, allows easy draw out and insertion of the disc, and can be inserted into a recording/playing unit from a predetermined direction, with the optical disc D inserted, having a main wall 11 formed opposite to the recording surface of the optical disc D; a side wall 12 which extends from the circumference of the main wall 11 and covers at least a part of the circumference of the optical disc D; a disc drop prevention member (a disc holding claw) 13 which extends from the side wall 12 to be parallel to the main wall 11 just like holding the optical disc D; and a handling area 14 which extends parallel to the main wall from the side wall of the opposite side to the predetermined direction to insert into a recording/playing unit.

More specifically, the main wall 11 is formed with the inside diameter slightly larger than the diameter of the optical disc D, and the side wall 12 is formed higher than the thickness of the optical disc D.

Therefore, the optical disc D is held with a small gap in the hollow space defined by the inside of the side wall 12 on the main wall 11.

In a predetermined location of the main wall 11, an opening 15 is provided, which when the cartridge 10 containing the optical disc D is loaded in a not shown recording/playing unit, allows a not-shown optical pickup (or, an optical head) to access the optical disc D, or recording and playing the information, and can avoid contact of the optical disc D to a disc motor (and a disc holder) that holds the optical disc D and rotates at a predetermined speed. The direction of forming the opening 15 is of course the cartridge inserting direction indicated by the arrow.

The disc holding claw 13, the handling projection 14 and the opening 15 can be formed in one piece with the cartridge 10 and in the same process by injection molding.

The disc holding claw 13 can prevent dropping of the optical disc D which is inserted into the hollow space defined by the main wall 11 and side wall 12, from the cartridge 10 (hollow space), even if the cartridge 10 is inclined in an optional direction. The disc holding claw 13 can be shifted to the side separating from the main wall 11, not to apply an undesirable pressure to the optional surface of the optical disc D, when the optical disc D is taken out from or set in the cartridge 10.

The handling projection 14 can prevent the user's finger from touching the optical disc D inside, when the cartridge 10 is loaded in or draw out from a not-shown recording/playing unit. The handling projection 14 is formed to permit the user to securely hold the cartridge 10.

The hollow space defined by the main wall 11 and side wall 12 of the cartridge 10 is 80 mm in diameter and 1.2 mm in thickness, for example, so as to contain the optical disc D when it is used in a video camera or the like.

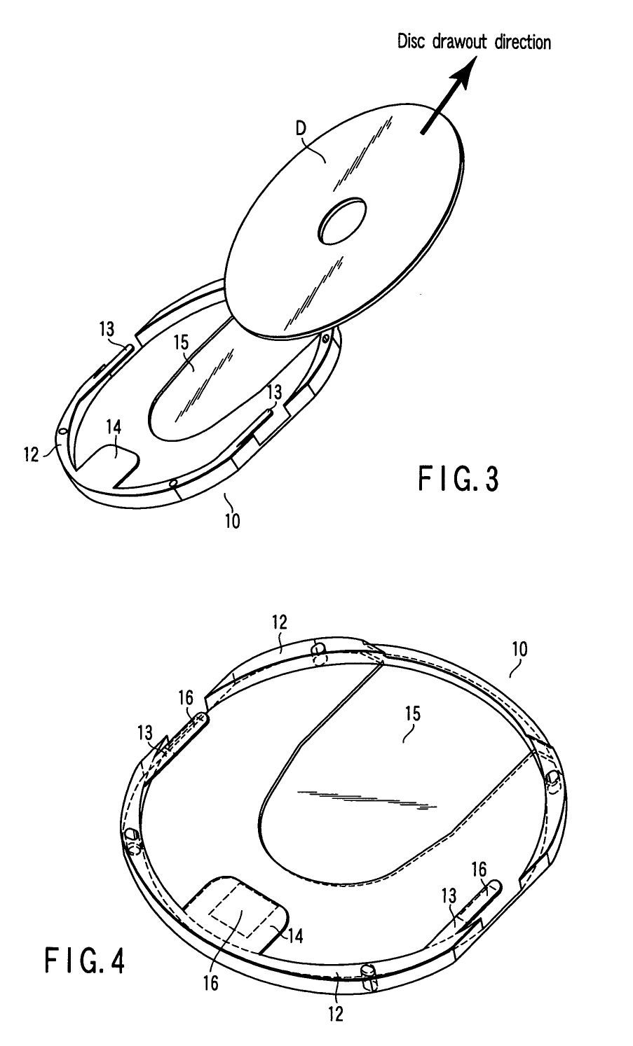

With the disc cartridge 10 explained in FIGS. 1A, 1B and FIG. 2, the user can take out the optical disc D by holding the center hole and one edge of the disc with fingers, and sliding the disc in the disc draw out direction shown in FIG. 3.

Contrarily, when setting the optical disc D in the disc cartridge 10, the user can easily fit the disc in the hollow space defined by the main wall 11 and side wall 12, by sliding the disc in the reverse direction to the arrow (the disc draw out direction) shown in FIG. 3.

In most cases, the recording surface of the optical disc D is hard coated, and in general using conditions, even if the disc holding claw 13 or the handling projection 14 or the both comes in contact with the recording surface of the disc, the information recorded in the optical disc D will be hardly influenced.

Further, as shown in FIG. 4, an undesired damage on the optical disc D can be securely prevented by covering the area 16, where the recording surface of the optical disc D may contact the main wall 11, the disc holding claw 13, the handling part 14 or the inside of each of these parts, by sticking a non-cover cloth or synthetic leather, or by coating or applying a material which prevents damages on the recording surface of the optical disc D. It is needless to say that when molding the cartridge 10, fiber-molded (simultaneous molding of the fibers or the like on the resin material surface) is allowed in the area where the recording surface of the optical disc D may come in contact with the other parts.

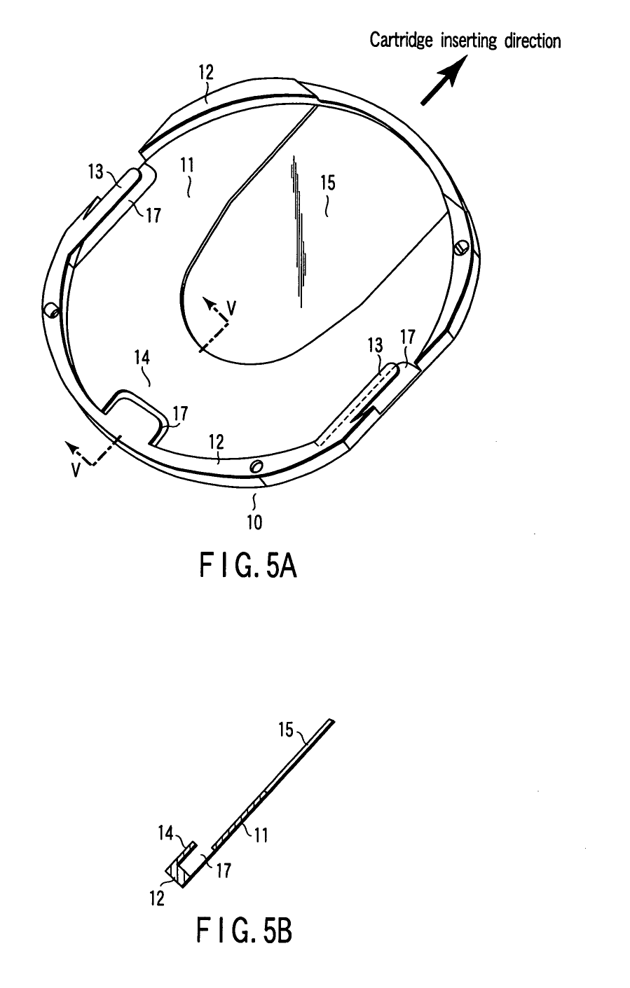

As shown in FIGS. 5A and 5B, the moveability of a mold used for molding can be increased and the cost of a not-shown molding machine can be decreased by providing a vent (a clearance) 17 which defines the operating direction of a mold, particularly a die insert, when molding, in the main wall 11 opposite to the position where the disc holding claw 13 and handling projection 14 are provided.

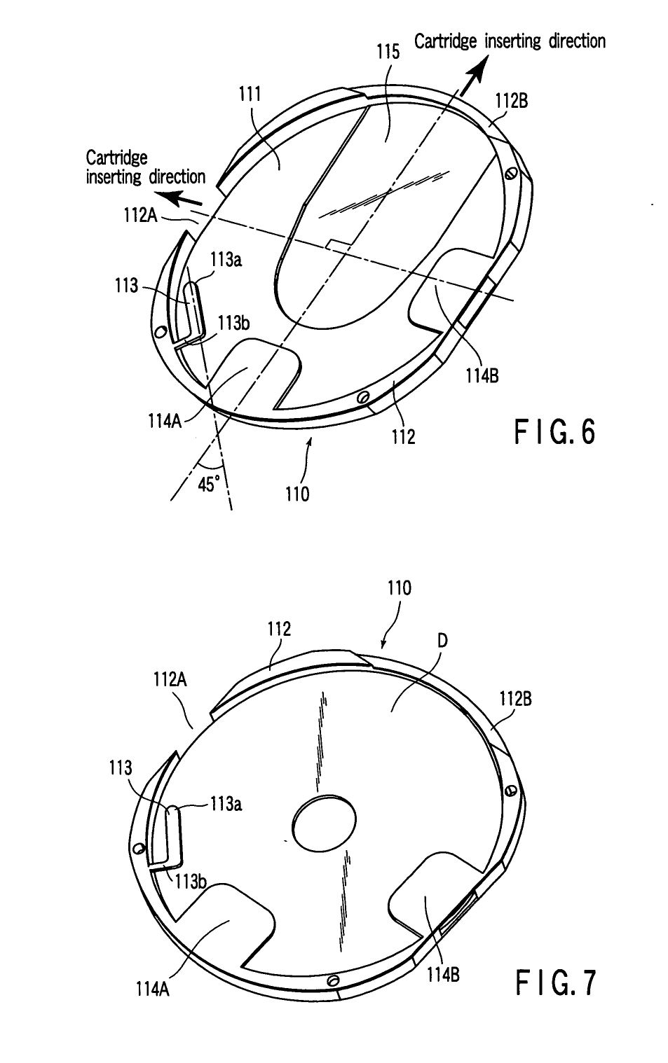

FIGS. 6 to 8 are the schematic diagrams showing a second example of a disc cartridge. The same or similar components as those shown in FIGS. 1A, 1B and FIG. 3 are designated by the same reference numerals plus 100, and the detailed explanation will be omitted.

As shown in FIGS. 6 to 8, the disc cartridge 110 comprises a main wall 111, a side wall 112, a disc holding claw 113 which is formed to hold an optical disc D (refer to FIG. 7) inserted into the hollow space defined between the main wall 111 and the side wall 112, between the main wall 111, first and second handling projections 114A, 114B, and an opening 115 which when the optical disc D is loaded in a not-shown disc drive unit (a recording/playing unit), allows an optical pickup or an optical head to access the optical disc D from the disc drive unit, that is, recording and playing the information, and can avoid contact of the optical disc D to a disc motor (and a disc holder) that holds the optical disc D and rotates at a predetermined speed.

In the predetermined location of the side wall 112, notches (or wall height limiting parts where the wall height is limited) 112A and 112B are formed, which when the disc cartridge 110 is held in or draw out from the disc drive unit, can decrease the possibility of undesired contact to the structure of the disc drive unit. The notches 112A and 112B are provided at an angle 90° from the center of the main wall 111. One of the notches 112A and 112B is provided almost parallel to the center line of the length direction of the opening 115 (the wall height is limited).

The disc holding claw 113 is formed at an angle almost the middle between the angle made by the two notches 112A and 112B so as to prevent the optical disc D from dropping from the cartridge 110, and not to influence the loading and unloading of the cartridge 110, when the disc cartridge is held in or draw out from the disc drive unit (hereinafter, referred to as loading/unloading) along the notches 112A and 112B in the side wall 112. Namely, the working part 113a of the holding claw 113 extends at an angle of about 45° against the center line of the length direction of the opening 115. The elastic part 113b which supports the working part 113a extends from the predetermined position of the side wall 112, not to cause undesired contact with the optical disc D loaded inside at the predetermined interval made between the main wall 111. The elastic part 113b is given the elasticity capable of changing the position of the working part 113a, not to apply an undesired pressure to an optional position of the optical disc D, even if the optical disc D contacts the working part 113a when the disc is inserted into or draw out from the cartridge 110.

The handling projections 114A and 114B are formed to prevent contact of the user's finger with the inside optical disc D, and to permit the user to hold securely the cartridge 10, when the cartridge 110 is loaded in or unloaded from a not-shown recording/playing unit.

The handling projections 114A and 114B are provided in the side opposite to the notches 112A and 112B, taking almost the center of the main wall 111 as an object axis. The hollow space between the handling projections 114A/114B and the main wall 111 is substantially equal to the hollow space between the disc holding claw 113 and the main wall 111.

In other words, the disc cartridge 110 includes a main wall 111 which is formed to be opposite to the recording surface of a recording medium D; an opening 115 which is provided in the main wall 111; a side wall 112 which extends from the circumference of the main wall 111, covers at least a part of the circumference of the recording medium D, and is provided with notches or wall height limiting parts with the limited height 112A, 112B that can decrease the possibility of contact with the structure of the recording/playing unit; at least one recording medium drop prevention member 113 which extends from the side wall 112 to be parallel to the main wall 111 just like holding the recording medium D; and at least one cartridge holding projection area 114 which is formed to prevent contacting the recording surface of the recording medium D.

More specifically, the main wall 111 is formed with the inside diameter slightly larger than the diameter of the optical disc D, and the distance from the side wall 112 and the handling projections 114A, 114B, to the main wall 111 is made higher than the thickness of the optical disc D. Therefore, the optical disc D is loaded with a small gap in the hollow space defined by the inside of the side wall 112 on the main wall 111, movably or rotatably in the predetermined direction.

The disc holding claw 113 can prevent the optical disc D which is held in the hollow space defined by the main wall 111 and side wall 112, from dropping from the cartridge 110 (hollow space), even if the cartridge 110 is inclined in an optional direction. The disc holding claw 113, the handling projections 114A, 114B, and the opening 115 can be formed in one piece with the cartridge 110 and in the same process by injection molding.

The hollow space defined by the main wall 111 and side wall 112 of the cartridge 110 is 80 mm in diameter and 1.2 mm in thickness, for example, so as to contain the optical disc D when it is used in a portable video camera or the like.

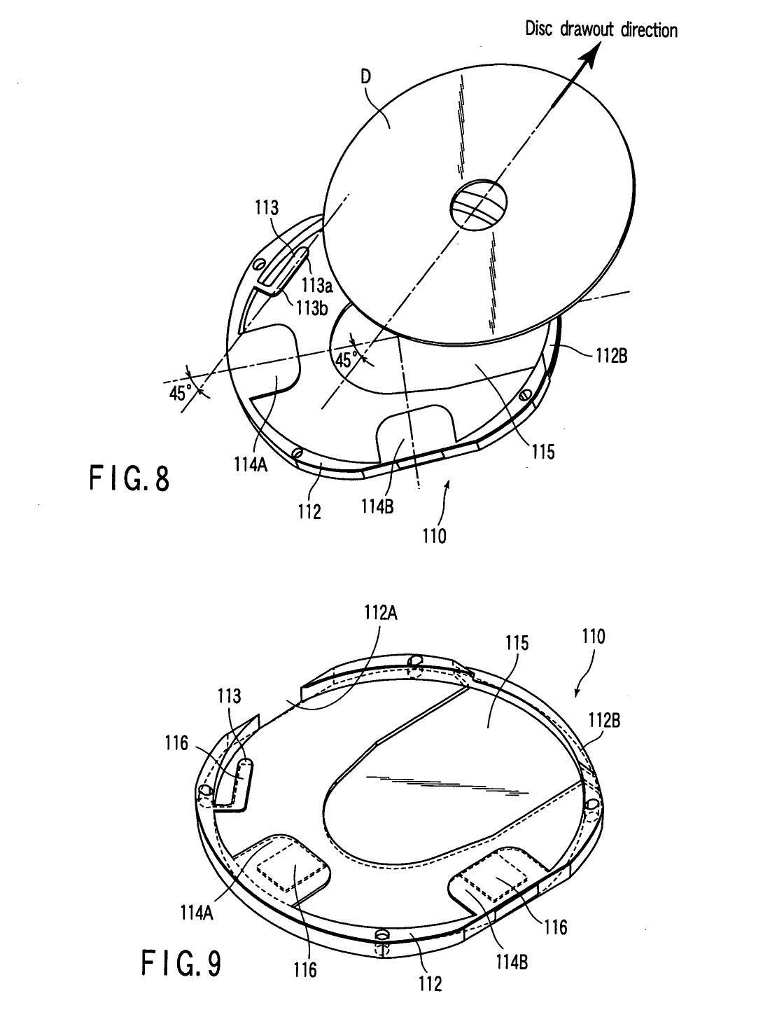

With the above-mentioned disc cartridge 110, the user can take out the optical disc D from the cartridge 110 by sliding the disc in the disc draw out direction shown in FIG. 8. When setting (loading) the optical disc D in the disc cartridge 110, the user can easily fit the disc in the hollow space defined by the main wall 111 and side wall 112, by sliding the disc D in the direction reverse to the arrow (the disc draw out direction) shown in FIG. 8.

Either when taking out the optical disc D from the disc cartridge 110 or when loading the disc in the cartridge 110, the disc holding claw 113 formed in one body with the side wall 112 and the first and second handling projections 114A, 114B prevent undesired dropping (coming off) of the optical disc D from the hollow space defined by the main wall 111 and side wall 112. Therefore, when exchanging the optical disc D outdoor, in particular, damages of the recorded data can be prevented and the reliability of the recorded information can be protected from being lowered.

In most cases, the recording surface the optical disc D is hard coated, and in general using conditions, even if the disc holding claw 113 or the handling projections 114A, 114B or the both contact the recording surface of the disc, the information recorded in the optical disc D will be hardly influenced.

Further, as shown in FIG. 9, an undesired damage on the optical disc D can be securely prevented by covering the area 116, where the recording surface of the optical disc D may contact the main wall 111, side wall 112, disc holding claw 113, or handling parts 114A, 114B, and in the hollow space defined by them, by sticking a non-weaved cloth or synthetic leather, or by coating or applying a material which prevents damage on the recording surface of the optical disc D. It is needless to say that when molding the cartridge 110, fiber-molded (simultaneous molding of the fibers or the like on the resin material surface) is allowed in the area where the recording surface of the optical disc D may contact.

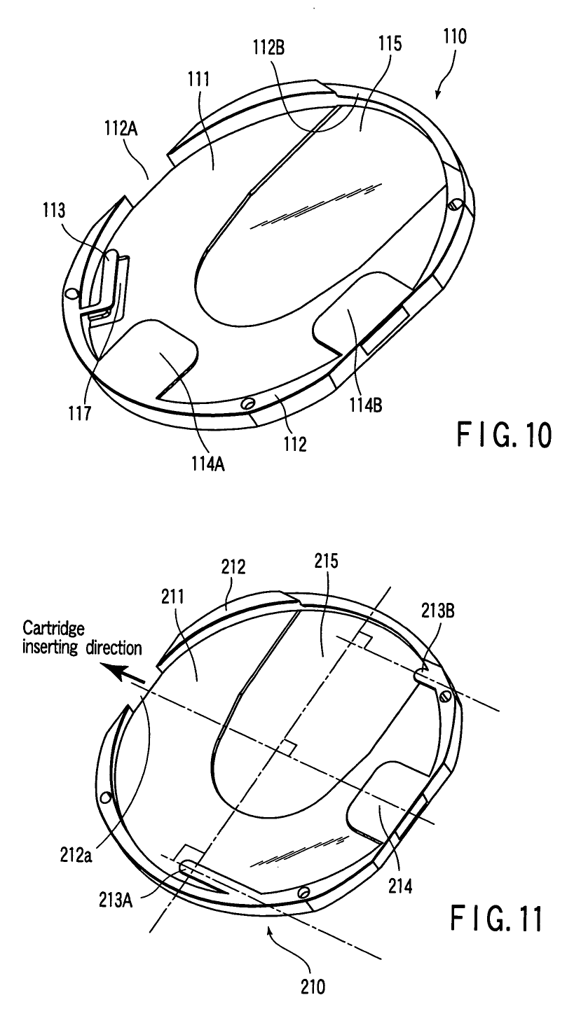

As shown in FIG. 10, the moveability of a mold used for molding can be increased and the cost of a not-shown molding machine can be decreased by providing a vent (a clearance) 117 which defines the operating direction of a mold, particularly a die insert, when molding, in the main wall 111 opposite to the position where the disc holding claw 113 is provided.

It is also possible to provide a clearance in the main wall 111 corresponding to the handling parts, but as the handling parts 114A and 114B need the dimensions to prevent contact of the user's finger to the optical disc D, and the clearance (a vent) may become undesirably large.

Thus, the size and quantity of the clearance is optionally determined depending on the moveability and cost of the mold.

FIGS. 11 to 13 are the schematic diagrams showing another example of a disc cartridge. The same or similar components as those shown in FIGS. 1A, 1B and FIG. 3 are designated by the same reference numerals plus 200, and the detailed explanation will be omitted.

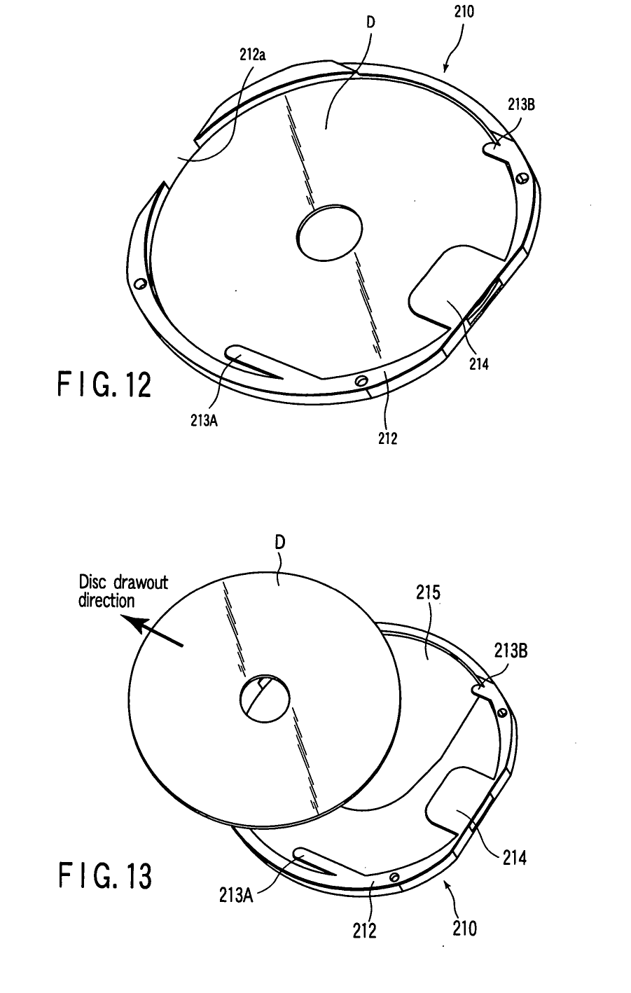

As shown in FIGS. 11 to 13, the disc cartridge 210 comprises a main wall 211, a side wall 212, first and second disc holding claws 213A, 213B which are formed to hold an optical disc D (refer to FIG. 12) inserted into the hollow space defined between the main wall 211 and the side wall 212, between the main wall 111, a handling projection 214, and an opening 215 which can avoid contact of the optical disc D to a not-shown disc motor and a not-shown optical pickup.

In the predetermined location of the side wall 212, a notch (or a wall height limiting part where the wall height is limited) 212a is formed, which when the disc cartridge 210 is loaded in or out off from the disc drive unit, can decrease the possibility of undesired contact to the structure of the disc drive unit. The notch 212a is provided in the direction almost orthogonal to the center line of the length direction of the opening 215. The first and second disc holding claws 213A and 213B are provided in the direction almost orthogonal to the center line of the length direction of the opening 215, and in two locations in the side wall 212 where they are almost symmetrical taking the center line of the length direction of the opening 215 as an axis of symmetry.

Of the two holding claws, the holding claw 213B of the side in which the opening 215 is formed close to the side wall 212, is limited in the length parallel to the main wall 211, compared with the opposite side holding claw 213A.

The handling projection 214 is formed to prevent contact of the user's finger with the inside optical disc D, and to permit the user to hold securely the cartridge 210, when the cartridge 210 is loaded in or unloaded from a not-shown recording/playing unit. The handling projection 214 is provided on the extension of the axis line connecting almost the center of the opening 215 and the notch 212a in the side wall 212, for example.

The hollow space between the handling projection 214 and the main wall 211 is substantially equal to the hollow space between the disc holding claws 213A, 213B, and the main wall 211.

Namely, the disc cartridge 210 (110) includes a flat part 211 (111) in which an opening 215 (115) is provided to permit setting the recording surface of a recording medium (an optical disc D) and the structure of a recording/playing unit, opposite to each other; a wall 212 (112A, 112B) which is formed in one body with the flat part 211 (111) in the circumference of the flat part 211 (111), and permits setting a recording medium in the hollow space defined between the flat part 211 (111); a notch or a wall height limiting part 212a (112A, 112B) with the decreased wall height, which is provided in a part of the wall 212 (112) to prevent contact with an optional part of the recording/playing unit, when the cartridge is inserted into or draw out from the recording/playing unit; and one of projection members 213A, 213B and 214 which are provided at least two and almost parallel to the wall 212 (112) to the flat part 211 (111), and can prevent the recording medium from going out of the hollow space defined by the flat part 211 (111) and the wall 212 (112), and prevent contact with the recording surface of the recording medium, when the cartridge is inserted into or draw out from the recording/playing unit, with the recording medium contained in the hollow space defined by the flat part 211 (111) and the wall 212 (112).

The disc holding claws 213A, 213B, the handling projection 214, and the opening 215 can be formed in one piece with the cartridge 210 and in the same process by injection molding, for example, like the cartridge explained before by using FIGS. 1A, 1B and FIG. 3.

With the above-mentioned disc cartridge 210, the user can take out the optical disc D from the cartridge 210 by sliding the disc in the disc draw out direction shown in FIG. 13. When setting (loading) the optical disc D in the disc cartridge 210, the user can easily set the disc in the hollow space defined by the main wall 211 and side wall 212, by sliding the disc in the direction reverse to the arrow (the disc draw out direction) shown in FIG. 13.

Either when taking out the optical disc D from the disc cartridge 210 or when loading the disc in the cartridge 210, the disc holding claws 213A, 213B formed in one body with the side wall 212 and the handling projection 214 prevent undesired dropping (coming off) of the optical disc D from the hollow space defined by the main wall 211 and side wall 212. Therefore, when exchanging the optical disc D outdoors, in particular, damages of the recorded data can be prevented and the reliability of the recorded information can be protected from being lowered. The recording surface of the optical disc D is usually hard coated, and in general using conditions, even if the disc holding claws 213A, 213B or the handling projection 214 or both contact the recording surface of the disc, the information recorded in the optical disc D will be hardly influenced.

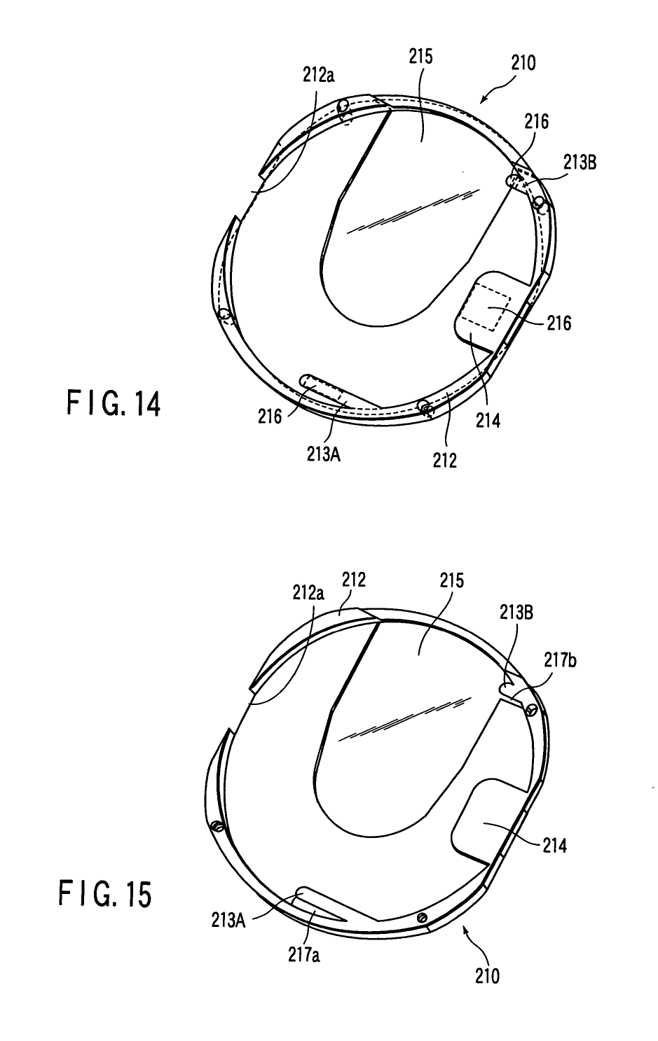

Further, as shown in FIG. 14, undesired damage to the optical disc D can be securely prevented by covering the area 216, where the recording surface of the optical disc D may contact in the main wall 211, side wall 212, disc holding claws 213A, 213B, or the handling part 214 and in the hollow space defined by them, by sticking a non-over cloth or synthetic leather, or by coating or applying a material which prevents damage to the recording surface of the optical disc D. It is needless to say that when molding the cartridge 210, fiber-molded (simultaneous molding of the fibers or the like on the resin material surface) is allowed in the area where the recording surface of the optical disc D may come in contact.

As shown in FIG. 15, the moveability of a mold used for molding can be increased and the cost of a not-shown molding machine can be decreased by providing vents (clearances) 217a, 217b which define the operating direction of a mold, particularly a die insert, when molding, in the main wall 211 opposite to the position where the disc holding claws 213A and 213B are provided. It is also possible to provide a clearance in the main wall 211 corresponding to the handling parts, but as the handling part 214 needs the dimensions to prevent contact of the user's finger to the optical disc D, and the clearance (a vent) may become undesirably large.

As explained above, in the disc cartridge according to the present invention, the insertion and draw out of an optical disc or a recording medium, and adhesion of the user's fingerprint on the recording surface of an optical disc, or undesired damage can be substantially prevented. The present invention is not to be limited to the above-mentioned embodiments, and various modifications are possible within the scope of the present invention. For example, it is of course possible to set optionally the position, number and shape of a disc holding claw.

That is, according to the present invention, it is possible to hold and take out securely an optical disc or a recording medium, without causing damage to the recorded data or decreasing the reliability of the recorded information.

Further, the cartridge fitting and removing directions will not be limited when inserting or removing a cartridge containing a disc into/from an optical disc unit.

Moreover, the disc cartridge of the present invention can be formed in one piece by injection molding, and the cost can be remarkably reduced.

The present invention is not limited to the embodiments described above and can be modified in various manners without departing from the spirit and scope of the invention.

For example, the present invention can provide a disc cartridge comprising a cover member which covers the recording surface of a recording medium except a predetermined area; a side wall which extends to a predetermined height from the circumference of the cover member; a handling area which extends from the side wall to make a predetermined angle against the cover member, and provides a predetermined interval against the recording surface of the recording medium; and a guide member which extends from the side wall to make a predetermined angle against the cover member, and can prevent coming off of the recording medium from the hollow space defined by the cover member and the side wall.

The present invention can also provide a disc cartridge comprising a cover member which has an opening, and is formed so that the opening and the surrounding area can be set opposite to the recording surface of a recording medium; a side wall which extends to a predetermined height from the circumference of the cover member; at least one cartridge holding projection area which extends from the side wall to be almost parallel to the cover member, and is formed to prevent contact to the recording surface of the recording medium; and at least one guide member which extends from the side wall to be almost parallel to the cover member, and is formed to prevent coming off of the recording medium from the hollow space defined by the cover member and the side wall.

The present invention can further provide a disc cartridge wherein the handling part is provided in the opposite side to the surface direction of the cover member with respect to the loading/unloading in/from a recording unit or a playing unit with the recording medium inserted into the hollow space.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disc cartridge which can rotatably contain and permits draw out of an optical disc having a recording surface, and can be inserted into a recording/playing unit from a predetermined direction with the recording medium inserted, comprising:
a main wall which is formed opposite to the recording surface of an optical disc;
a side wall which extends from the circumference of the main wall, and covers at least a part of the circumference of the optical disc;
a disc drop prevention member which extends from the side wall to be parallel with the main wall just like surrounding the optical disc; and
a handling projection area which extends parallel to the main wall from the side wall opposite to the predetermined direction when inserting into the recording/playing unit.

2. A disc cartridge according to claim 1, wherein the main wall has a window for an optical pickup head and a spindle motor.

3. A disc cartridge according to claim 1, wherein more than one disc drop prevention member is provided.

4. A disc cartridge according to claim 1, wherein a clearance part to define the operating direction of a molding machine, is provided in the area of the main wall opposite to the disc drop prevention member and the handling projection area.

5. A disc cartridge according to claim 1, wherein the main wall, the disc drop prevention member and the handling projection area are molded at the same time.

6. A disc cartridge according to claim 1, wherein the main wall, the disc drop prevention member, the handling projection area and the clearance part are molded at the same time.

7. A disc cartridge according to claim 1, wherein the disc drop prevention member can be temporarily deformed when the optical disc is inserted or draw out.

8. A disc cartridge according to claim 1, further comprising a preventive or coating to prevent undesired damage to the optical disc, provided in the side of the disc drop prevention member and the handling projection area, facing the optical disc.

9. A disc cartridge according to claim 8, wherein a clearance part to define the operating direction of a molding machine is provided in the area of the main wall opposite to the disc drop prevention member and the handling projection area.

10. A disc cartridge according to claim 8, wherein the main wall, the disc drop prevention member and the handling projection area are molded at the same time.

11. A disc cartridge according to claim 8, wherein the main wall, the disc drop prevention member, the handling projection area and the clearance part are molded at the same time.

12. A disc cartridge which can rotatably contain and permits draw out of a disc-like recording medium having a recording surface, and can be inserted into a recording/playing unit from a predetermined direction with the recording medium inserted, comprising:
a main wall which is formed opposite to the recording surface of an optical disc;
an opening which is provided in a predetermined location of the main wall;
a side wall which extends from the circumference of the main wall, and covers at least a part of the circumference of the optical disc;
at least one recording medium drop prevention member, which extends from the side wall to be parallel with the main wall just like surrounding the optical disc; and
at least one cartridge holding projection area, which can prevent contact with the recording surface of the recording medium, when inserting into the recording/playing unit.

13. A disc cartridge according to claim 12, wherein at least two notches are provided in the side wall in the almost orthogonal direction, and at least one notch is directed to the direction almost equal to the length direction of the opening.

14. A disc cartridge according to claim 12, wherein the cartridge holding projection area is provided opposite to the notches on the side wall reverse to the direction in which the notches are provided, taking a predetermined position of the opening as a point of symmetry.

15. A disc cartridge comprising:
a flat part which includes an opening to expose the recording surface of a recording medium to be contained, and occupies a main area;
a side wall which is formed in one body with the flat part in the circumference of the flat part, and contains the recording medium in the hollow space defined by the flat part;
a notch which is provided in a part of the side wall in one body with the flat part; and
at least two projection members in the side wall and almost parallel to the flat part, which can prevent the recording medium from going out of the hollow space and contacting the recording surface of the recording medium, with the recording medium contained in the hollow space.
